(19) United States
(12) Patent Application Publication
(10) Pub. No.: US 2011/0312197 A1
(43) Pub. Date: Dec. 22, 2011

(54) PORTABLE CONNECTOR DEVICE

(75) Inventor: WEN-PING LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/889,609

(22) Filed: Sep. 24, 2010

(30) Foreign Application Priority Data
Jun. 21, 2010 (CN) 201020231380.7

(51) Int. Cl. H01R 13/44

(52) U.S. Cl. 439/142

(57) ABSTRACT

An exemplary embodiment of a portable connector device includes a cap member and a main body rotating relative to the member. The main body includes a connector. The portable connector device further includes a connecting structure for connecting the cap member and the main body. The connecting structure connects the cap member and the main body, allowing a limited angle of rotation, to close or open the cap member to the connector.

### BACKGROUND

1. Technical Field

The disclosure generally relates to portable connector devices, and more particularly, relates to a portable connector device with a cap member.

2. Description of the Related Art

Portable connector devices usually have external interfaces, such as universal serial bus (USB), for electrically connecting to printers, computers or other peripheral devices. Such external devices should be protected by corresponding cap structures from e.g., dust or water, to maintain proper operation and functioning.

However, the cap structures and the external devices are separate elements to each other, and the cap structures are usually detachable from the external devices. Thus, the cap structures may be easily misplaced or lost when not covering the external devices.

Therefore, there is room for improvement within the art.

### BRIEF DESCRIPTION OF THE DRAWINGS

Many aspects of an exemplary portable connector device can be better understood with reference to the following drawings. The components in the drawings are not necessarily drawn to scale, the emphasis instead being placed upon clearly illustrating the principles of the exemplary portable connector device. Moreover, in the drawings, like reference numerals designate corresponding parts throughout the several views. Wherever possible, the same reference numbers are used throughout the drawings to refer to the same or like elements of an embodiment.

FIG. 1 is a partially exploded view of a portable connector device including a cap member, according to an exemplary embodiment.

FIG. 2 is an assembled view of the portable connector device with the cap member opened as shown in FIG. 1.

FIG. 3 is similar to FIG. 2, but viewed from the other aspect.

FIG. 4 is an assembled view of the portable connector device with the cap member closed as shown in FIG. 2.

### DETAILED DESCRIPTION

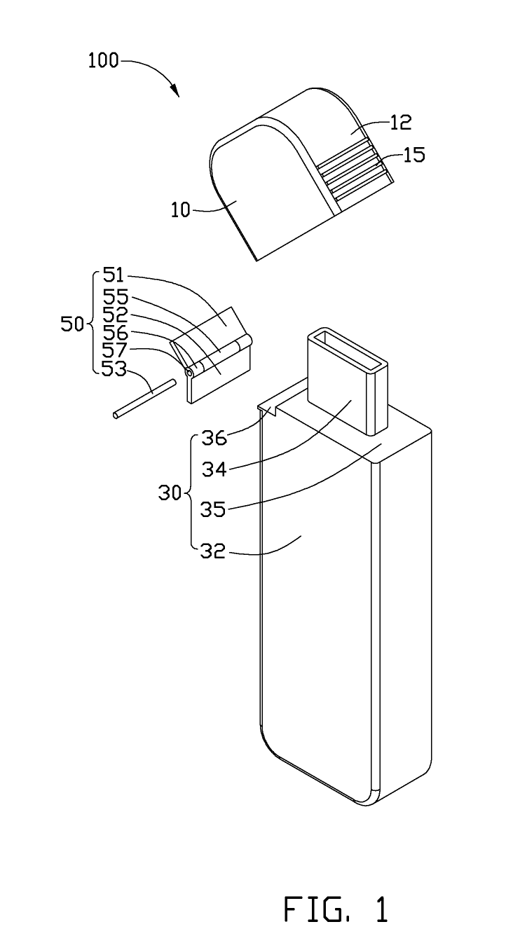

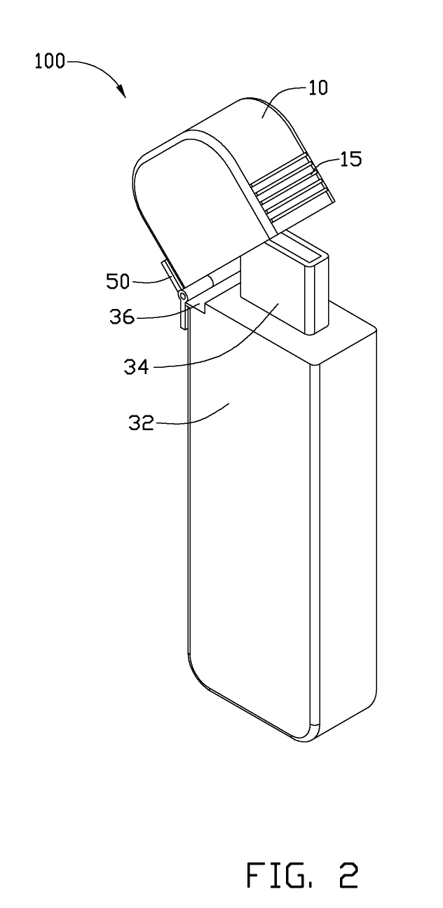

FIGS. 1 and 2 show an exemplary embodiment of a portable connector device 100 for electrically connecting to a computer or other electronic device. The portable connector device 100 maybe a wireless network interface controller or flash memory and includes a cap member 10, a main body 30, and a connecting structure 50 for connecting the cap member 10 and the main body 30.

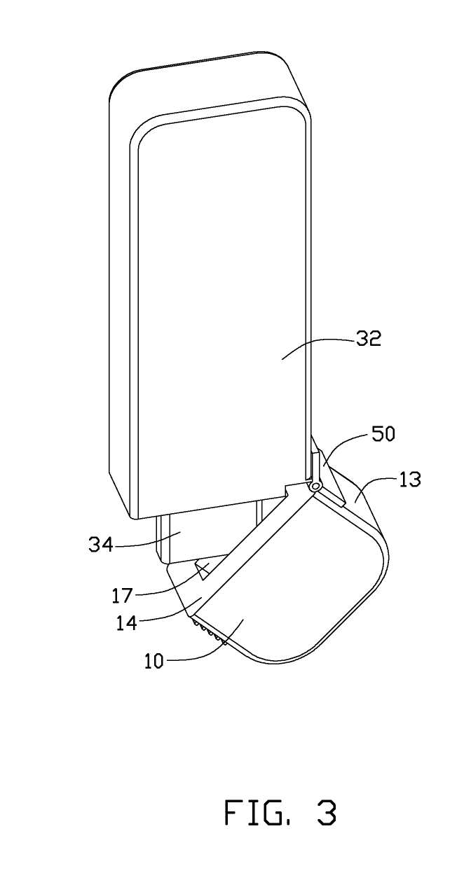

Referring to FIG. 3, the cap member 10 is substantially rectangular and includes a first sidewall 12, a second sidewall 13, and an end wall 14. The first sidewall 12 and the second sidewall 13 are positioned at opposite sides of the cap member 10 and are parallel to each other. The end wall 14 is perpendicularly connected between the first sidewall 12 and the second sidewall 13.

The first sidewall 12 includes a plurality of flange sections 15 protruding from the surface of the first sidewall 12. The flange sections 15 are substantially parallel strips. The flange sections 15 are for gripping the cap member 10 to allow the user to more conveniently open the cap member 10. The second sidewall 13 is mechanically connected to the connecting structure 50. The cap member 10 defines a receiving space 17 located at the middle or adjacent to the middle of the end wall 14. The receiving space 17 passes through the surface of the end wall 14.

The main body 30 includes a base member 32 and a connector 34. The base member 32 is substantially rectangular shape and includes an end surface 35 and a recess surface 36 recessed from the end surface 35. The end surface 35 is connected to the recess surface 36, substantially forming a step-shaped surface. The base member 32 is capable of storing corresponding functional circuits, such as modulation/demodulation circuits, signal transmission circuits, and memory circuits.

The connector 34 can be a USB connector, or a universal asynchronous receiver/transmitter (UART) connector and its shape and size are correspondingly matchable with the receiving space 17 of the cap member 10. The connector 34 perpendicularly protrudes out from the end surface 35 and is electrically connected to the functional circuits to receive, transmit or write, read different data with computers, mobile phones and other electronic devices.

The connecting structure 50 can be an hinge that connects to the cap member 10 and the main body 30, typically allowing only a limited angle of rotation between them. The connecting structure 50 includes a first leaf 51, a second leaf 52, and a hinge pin 53. The first leaf 51 and the second leaf 52 rotate relative to each other about the hinge pin 53. The first leaf 51 and the second leaf 52 are substantially rectangular plates as a whole, and are connected to the second sidewall 13 of the cap member 10 and the side of the base member 32 adjacent to the recess surface 36, respectively, by hot melt, solder or other process for securing.

The first leaf 51 includes a first barrel 55 at the edge of the first leaf 51. The second leaf 52 includes two second barrels 56 located at opposite ends of the second leaf 52. Each first and second barrel 55, 56 defines a through hole 57, and the size and the shape of the through holes 57 substantially match the size and the shape of the hinge pin 53. Thus, the hinge pin 53 can be detachably received within the through holes 57. In practice, the number of the second barrels 56 may be one, and the other second barrel 56 may be omitted. Thus, the first leaf 51 and the second leaf 52 still rotate relative to each other about the hinge pin 53.

When the second leaf 52 is assembled to the base member 32, the first barrel 55 and the second barrels 56 are mounted on the recess surface 36, and their heights are substantially equal to the height difference between the recess surface 36 and the end surface 35. Thus, the first barrel 55 and the second barrels 56 are leveled with the end surface 35, and the cap member 10 can completely cover the connector 34. Moreover, when the cap member 10 is opened relative to the main body 30, the end wall 14 of the cap member 10 is leveled with the end surface 35, so that the connector 34 can be fully exposed and inserted into the computers, the mobile phones and other electronic devices.

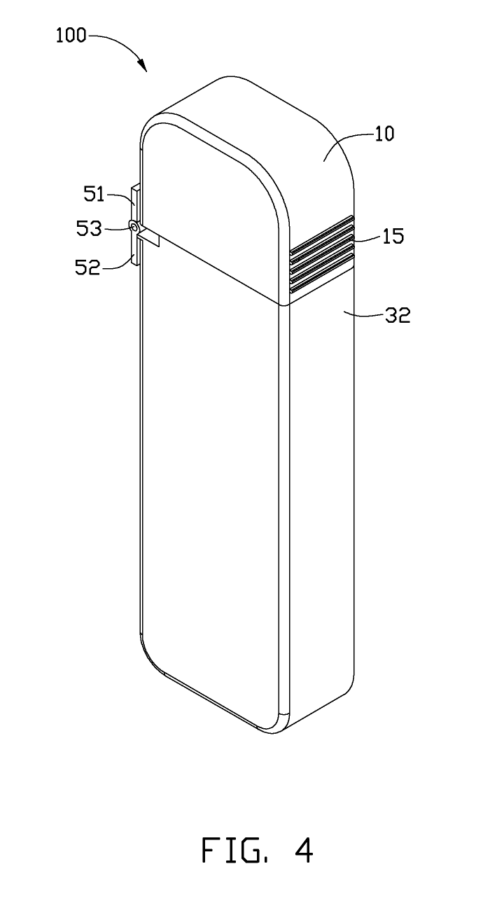

Further referring to FIGS. 3 and 4, in assembly, the hinge pin 53 is aligned with and is inserted into the through holes 57, therefore, the first leaf 51 and the second leaf 52 rotate relative to each other about the hinge pin 53. The second leaf 52 is assembled to one side of the main body 30 through the way of hot melt, solder or other process for securing, and the first barrel 55 and the second barrel 56 are mounted on the recess surface 36. The first leaf 51 is assembled to the sidewall 13 of the cap member 10 by the way of hot melt, solder or other process for securing. By rotating the cap member 10, the connector 34 can be fully received within the receiving space 17 of the cap member 10. Thus, the cap member 10 is assembled to the main body 30 through the connecting structure 50.

In use, by pushing the flange sections 15 of the first sidewall 12, the cap member 10 rotates relative to the main body 30 about the hinge pin 53 until the connector 34 is fully removed out from the receiving space 17. The end wall 14 is leveled with the end surface 35, therefore, the connector 34 of the portable connector device 100 is inserted within the corresponding connector of the computer or the mobile phone to transmit data.

In addition, the connecting structure 50 can be made from polyethylene, polystyrene, polyvinylchloride (PVC) or other insulating material, resulting in the prevention of the connecting structure 50 from generating radio frequency interference when the portable connector device 100 is in use.

In summary, the portable connector device 100 of the exemplary embodiment has a simple structure and is easy to use. The cap member 10 is rotatably connected to the main body 30 about the connecting structure 50, typically allowing a right angle of rotation between them, to open or close the cap member 10 relative to the main body 30, which can avoid outside moisture, or dust from getting into the connector 34. Moreover, in use, the cap member 10 is rotatably connected to the main body 30. Thus, the cap member 10 can not be misplaced or lost when not covered on the connector 34.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A portable connector device, comprising:
a cap member;
a main body; and
a connecting structure for connecting the cap member and the main body, wherein the cap member is rotatably connected relative to the main body about the connecting structure to close or open one end of the main body.

2. The portable connector device as claimed in claim 1, wherein the cap member comprises a first sidewall, a second sidewall, and an end wall, the first sidewall and the second sidewall are parallel positioned at opposite sides of the cap member, and the end wall is perpendicularly connected between the first sidewall and the second sidewall.

3. The portable connector device as claimed in claim 2, wherein the first sidewall comprises a plurality of parallel flange sections protruding from the surface of the first sidewall, the flange sections for increasing a user's grip on the cap member.

4. The portable connector device as claimed in claim 2, wherein the cap member defines a receiving space located at the middle or adjacent the middle of the end wall, the receiving space passes through the end wall, and the main body comprises a connector, the cap member rotates relative to the main body to expose or cover the connector.

5. The portable connector device as claimed in claim 4, wherein the main body further comprises a base member, the base member comprises an end surface and a recess surface recessed from the end surface, and the end surface is connected to the recess surface to form a step-shaped surface.

6. The portable connector device as claimed in claim 5, wherein the base member is capable of storing different functional circuits and the connector protrudes out from the end surface and is electrically connected to the functional circuits to transmit different data.

7. The portable connector device as claimed in claim 5, wherein the connecting structure comprises a first leaf, a second leaf, and a hinge pin, the first leaf and the second leaf rotate relative to each other about the hinge pin, and the first leaf and the second leaf are connected to the second sidewall of the cap member and one side of the main body.

8. The portable connector device as claimed in claim 7, wherein the first leaf comprises a hollow first protrusion, and the second leaf comprises a hollow second protrusion, the hinge pin passes through and is received within the first barrel and the second protrusion.

9. The portable connector device as claimed in claim 7, wherein the first barrel and the second protrusion are mounted on the recess surface, and their heights are substantially equal to the height difference between the recess surface and the end surface to open or close the cap member and insert the connector.

10. The portable connector device as claimed in claim 1, wherein the portable connector device is a wireless network interface controller, and the connecting structure is made from insulating materials to prevent connecting structure generating radio frequency interference when the portable connector device in use.

11. A portable connector device, comprising:
a cap member;
a main body rotating relative to the cap member, the main body comprising a connector; and
a connecting structure for connecting the cap member and the main body, wherein the connecting structure connects the cap member and the main body, allowing a limited angle of rotation, to close or open the cap member to the connector.

12. The portable connector device as claimed in claim 11, wherein the cap member comprises a first sidewall, a second sidewall, and an end wall, and the first sidewall and the second sidewall are parallel positioned at opposite sides of the cap member, the end wall is perpendicularly connected between the first sidewall and the second sidewall.

13. The portable connector device as claimed in claim 12, wherein the first sidewall comprises a plurality of parallel flange sections protruding from the surface of the first sidewall, the flange sections for increasing a user's grip on the cap member.

14. The portable connector device as claimed in claim 12, wherein the cap member defines a receiving space located at the middle or adjacent the middle of the end wall, the receiving space passes through the end wall, and the cap member rotates relative to the main body to remove the connector out or in the receiving space.

15. The portable connector device as claimed in claim 14, wherein the main body further comprises a base member, the base member comprises an end surface and a recess surface recessed from the end surface, and the end surface is connected to the recess surface to form a step-shaped surface.

16. The portable connector device as claimed in claim 15, wherein the base member is capable of storing different functional circuits and the connector protrudes out from the end surface and is electrically connected to the functional circuits to transmit different data.

17. The portable connector device as claimed in claim 15, wherein the connecting structure comprises a first leaf, a second leaf, and a hinge pin, the first leaf and the second leaf rotate relative to each other about the hinge pin, and the first leaf and the second leaf are connected to the second sidewall of the cap member and one side of the main body.

18. The portable connector device as claimed in claim 17, wherein the first leaf comprises a first protrusion, and the second leaf comprises a second protrusion, the first barrel comprises a through hole, and the second protrusion comprise a through hole, the hinge pin passes through and is received within the through holes.

19. The portable connector device as claimed in claim 17, wherein the first barrel and the second protrusion are mounted on the recess surface, and their heights are substantially equal to the height difference between the recess surface and the end surface to open or close the cap member and insert the connector.

20. The portable connector device as claimed in claim 10, wherein the portable connector device is a wireless network interface controller, and the connecting structure is made from insulating materials to prevent the connecting structure generating radio frequency interference when the portable connector device in use.
